(19) United States
(12) Patent Application Publication
(10) Pub. No.: US 2011/0303404 A1
(43) Pub. Date: Dec. 15, 2011

(54) Wear-Resistant Conformal Coating for Micro-Channel Structure

(75) Inventor: Nim Tea, Cupertino, CA (US)

(73) Assignee: Irvine Sensors Corporation, Costa Mesa, CA (US)

(21) Appl. No.: 13/155,986

(22) Filed: Jun. 8, 2011

Related U.S. Application Data
(60) Provisional application No. 61/397,568, filed on Jun. 14, 2010.

(51) Int. Cl. F28F 21/08; B23P 25/00

(52) U.S. Cl. 165/180; 29/458

(57) ABSTRACT

A conformal, multilayer micro-channel structure having a wear-resistant interior micro-channel surface coating of an ALD deposited conformal alumina (Al2O3) ceramic of about 1000 Å in thickness and a titanium nitride (TiN) of about 300 Å to about 1000 Å in thickness. The Al2O3/TiN multilayer structure is resistant to erosion and to electro-chemical corrosion as is found in prior art micro-channel coolers and structures.

### CROSS-REFERENCE TO RELATED APPLICATIONS

This application claims the benefit of U.S. Provisional Patent Application No. 61/397,568, filed on Jun. 14, 2010 entitled “Wear-resistant Conformal Multilayer Structure” pursuant to 35 USC 119, which application is incorporated fully herein by reference.

### STATEMENT REGARDING FEDERALLY SPONSORED RESEARCH AND DEVELOPMENT

N/A

### BACKGROUND OF THE INVENTION

1. Field of the Invention

The invention relates generally to the field of wear-resistant coatings for surfaces of very small feature devices such as micro-channel cooler devices. More specifically, the invention relates to a method and device for providing a wear-resistant coating to a surface of micro-channel structure such as a micro-channel cooler for use with an electronic or micro-electromechanical device.

2. Description of the Related Art

Various microelectronic and MEMS devices comprise one or more channel structures, some of which may have an inner diameter of less than 100 microns in which a fluid, such as water acting as a coolant, flows under pressure (“micro-channels” herein). For example, certain MEMS devices may comprise micro-channel heat exchangers used for the transfer of heat from a first location (e.g., an operating circuit) to a second location (e.g., a heat radiating means for dissipating excess heat to the environment) using a MEMS-based micro-pump assembly. One example of a micro-channel structure application is a micro-channel cooler (MCC) used to cool modern high power laser diodes that may have a power dissipation of ≧100 W/cm2.

Prior art copper (Cu) micro-channel heat exchangers are a relatively well-developed area of technology used in high power electronic cooling applications such as the aforementioned high power laser diode circuit operation. The thermal performance and reliability of such prior art copper micro-channel heat exchangers are also well studied and understood.

Unfortunately, the exposed surfaces of the above prior art electro-plated Cu micro-channel cooler heat exchangers tend to suffer from mechanical erosion of the relatively soft Ni/Au micro-channel surface plating with which they are provided from the fluid flow within the channels. Further, the surfaces also tend to sustain chemical-electrochemical corrosion due, in part, to the fact the Ni/Au passivation is not always 100% hermetic (i.e., the Ni/Au layer may contain pin-holes or voids).

The above failure mechanisms in prior art Cu micro-channel cooler devices result in added system complexity and increased cost by requiring the use of DI water with attendant DI water source maintenance.

Prior art attempts to minimize the above failure modes in high power laser applications have included both the use of ceramic (low temperature, co-fired ceramic) micro-channel coolers and the use of complex design approaches in the packaging of the Cu micro-channel cooler/laser diode assembly; all in an attempt to improve the overall thermal performance of the system.

Atomic layer deposition (ALD) is an emerging process technology that is capable of depositing hermetic (i.e., pin-hole free), conformal, ultra-thin film coatings one atomic layer at a time. In addition to these benefits, a wide range of materials (metals, oxides, nitrides) can be deposited using this process. ALD process technology has been applied to a limited number of MEMS devices such as mechanical oscillators but application to micro-channel coating is yet unknown.

The passivation parameters of interest in micro-channel applications include: 1) the coating should be conformal, 2) the coating should be pin-hole free, and, 3) the coating should be mechanically hard so as to resist wear under high velocity water flow.

Because the electrical current used to operate a laser diode assembly and the cooling water itself are in electrical communication within the micro-channel cooler, de-ionized (DI) water is currently required to minimize electro-chemical corrosion. Unfortunately, by requiring DI water in such systems, a water monitoring system must actively monitor and control the electrical resistance and pH of the water coolant in addition to monitoring the water pressure and flow; all resulting in a significantly more complex supporting thermal system.

A prior art method for copper micro-channel cooler interior surface passivation employs an electroplated coating of Ni/Au multilayers. The prior art Ni/Au coating has the undesirable characteristic of being non-uniform in high-aspect-ratio channels, is difficult to use to achieve pin-hole free application, and is electrically conductive with the high velocity cooling water.

Further, the supplied gold plating in such applications is relatively soft (55 kg/mm2 hardness) and tends to erode under the high velocity water flow in the channels. Yet further, state-of-the-art electroplating processes used in high-aspect-ratio micro-channels typically cannot achieve a uniform coating thickness, especially around sharp bends and is prone to pin-holes.

A prior art commercially available high-power laser diode subassembly is typically soldered directly to the copper micro-channel cooler. In such a configuration, when the laser is powered, its electrical current is in electrical connection with the cooling water in the channels. Any pin-holes in the supplied electroplated Ni/Au protective coating permit electro-chemical corrosion if the DI water is not properly maintained. Thus, prior art protective coatings that are not 100% pin-hole free tend to result in unreliable thermal performance. If the thermal control is unpredictable, the laser operating life is also unpredictable.

What is needed to overcome the above deficiencies in prior art micro-channel coolers and other applications is a high hardness, thin passivation layer that can be applied to uneven, non-planar surfaces such as copper micro-channels and a device comprising such micro-channel structures so as to improve the reliability and operating life of the micro-channel structures and related assemblies such as high power laser diodes and to reduce the overall thermal management complexity in a system comprising one or more micro-channel coolers.

To address these and other deficiencies in the prior art, Applicant therefore discloses a pin-hole free, wear-resistant, multilayer coating and a micro-channel structure comprising such multilayer coating to enable reliable thermal performance of a micro-channel cooler or other structure.

### BRIEF SUMMARY OF THE INVENTION

A very thin wear-resistant, conformal multilayer structure and process for making same is disclosed that takes advantage of atomic layer deposition (ALD) processes that provides a thin, conformal coating to uneven, non-planar surfaces such as the interior surface of a micro-channel cooler and also offers a wide selection of deposition materials.

The ALD process is a self-limiting layering process that is deposited one atomic layer at a time. A preferred embodiment of the wear-resistant, conformal multilayer structure of the invention comprises a protective coating of a conformal alumina (Al2O3) ceramic of about 1000 Å in thickness and a coating of titanium nitride (TiN) of about 300 Å to about 1000 Å in thickness. The innovative Al2O3/TiN multilayer structure is resistant to erosion (wear) and to electro-chemical corrosion.

In a first aspect of the invention, a micro-channel structure is provided comprised of at least one micro-channel volume comprising an interior surface and having at least one layer of a predetermined material have a predetermined hardness, corrosion resistance or other physical property deposited on the interior surface by an atomic layer deposition process.

In a second aspect of the invention, a method for making a micro-channel structure is provided comprising the steps of providing a first partial micro-channel structure having at least one first partial micro-channel volume defined therein, providing a second partial micro-channel structure having at least a second first partial micro-channel volume defined therein, depositing a predetermined material on the surface of the first and second partial micro-channel volumes using an atomic layer deposition process, and assembling the first and second partial micro-channel structures to define a micro-channel structure comprising at least one micro-channel volume.

These and various additional aspects, embodiments and advantages of the present invention will become immediately apparent to those of ordinary skill in the art upon review of the Detailed Description and the claims that follow.

While the claimed apparatus and method herein has or will be described for the sake of grammatical fluidity with functional explanations, it is to be understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112, are to be accorded full statutory equivalents under 35 USC 112.

### BRIEF DESCRIPTION OF THE SEVERAL VIEWS OF THE DRAWINGS

FIGS. 1A, 1B and 1C depict a cross-section of a first partial micro-channel structure at various stages in the ALD process.

FIG. 2 is a cross-section of a first micro-channel structure and illustrates the ALD reaction cycle with the first and second reactants.

FIG. 3 illustrates a cross-section of the first partial micro-channel structure of FIG. 1C having an ALD wear-resistant, conformal coating thereon assembled with and bonded to a second partial micro-channel structure to define a micro-channel assembly comprising a plurality of wear-resistant micro-channels.

The invention and its various embodiments can now be better understood by turning to the following Detailed Description of the preferred embodiments which are presented as illustrated examples of the invention defined in the claims. It is expressly understood that the invention as defined by the claims may be broader than the illustrated embodiments described below.

### DETAILED DESCRIPTION OF THE INVENTION

Turning now to the figures wherein like numerals define like elements among the several views, a wear-resistant structure such as a micro-channel structure functioning as a micro-channel cooler, is disclosed.

In a preferred embodiment, the wear-resistant, conformal multilayer structure coating is comprised of at least two deposition layers; an insulating hard ceramic followed by a conductive hard coating. Both layers are submicrons thick and are deposited using an ALD or chemical vapor ALD process.

Atomic layer deposition is an ultra-thin film deposition technique that offers very precise control of the composition, conformal layering over high-aspect-ratio structures, and thickness control at the atomic level. The deposited thin film also has excellent surface flatness with well-defined vertical edge profiles and smoothness. The deposition variables that make ALD attractive include low process temperature, the self-limiting nature of the deposition process, and the choice of deposited materials (metals, oxides, and nitrides). High quality dense films can be deposited at low temperatures of 100° C. to 150° C. which temperatures are compatible with most polymers (e.g., photo-resists) commonly used in semiconductor and MEMS fabrication processes.

It has been shown that Al2O3 thin film deposited by ALD can be readily patterned using semiconductor photo-resist liftoff processes with excellent continuity, with roughness similar to the underlying device surfaces and with minimum feature size. ALD's self-terminating process provides that, unlike physical deposition, the material deposition does not require a direct line of sight. As a result, high-aspect-ratio structures with complex geometries such as micro-channel structures can be coated conformally.

In the preferred method of practicing the invention, a first layer of Al2O3, or alumina with a thickness of about 1000 Å is deposited on a predetermined surface or portion of a structure such as a micro-channel structure, using a CVALD process. This is essentially a process for conformal vapor phase coating that is built-up one atomic layer at a time.

After application of the Al2O3 layer however, pin-holes may remain due to irregularities of the structure, such as the copper micro-channel cooler surface topology. A second, harder layer of titanium nitride having a thickness of about 300 Å to about 1000 Å is then deposited using the same CVALD process and equipment to hermetically seal any micro-pin-holes that may exist. This multilayer coating ensures highly reliable thermal operation for structures such as Cu micro-channel cooler heat exchangers.

The disclosed wear-resistant, conformal multilayer structure process technology provides many important advantages compared to conventional electroplating techniques for passivation of copper micro-channel heat exchangers. These advantages include:

1. The process provides a pin-hole free coating that is a conformal, hermetic layer deposited by vapor phase growth one atomic layer by layer. It evenly coats around bending angles and surface irregularity as are common in micro-channel or other fine feature structures. The coating surface is atomically smooth and conforms to the underlying substrate topology.

2. The deposited wear-resistant, conformal multilayer coating of the invention is very thin with a total thickness of <0.2 um and practically presents no added thermal impedance to the thermal performance of a copper micro-channel cooler heat exchanger.

3. The multilayer coating comprises two very hard materials—the first layer is an insulating alumina ceramic with a hardness of about 1440 kg/mm2. The second layer is titanium nitride with a hardness of about 3260 kg/mm2. This wear-resistant, conformal multilayer structure coating has near zero wear when subjected to a water flow rate of 0.05 gallon per minute, as is typically found in operation of Cu micro-channel cooler devices.

4. Titanium nitride and alumina ceramic are highly resistant to chemical corrosion. Both materials are inert and safe for use even in human implantation.

5. Unlike electroplated Ni/Au passivation where gold corrosion can easily occur in the present of chloride anion and voltage/current, TiN and alumina ceramic are both insoluble; hence, they have superior resistance to electrochemical corrosion.

6. CVALD process temperatures are very low, i.e., about 70 C to about 150 C and accommodate thermal mismatch processing concerns. CVALD is also a batch process which results in low cost.

7. A wide range of materials (metals, oxides, nitrides) can be deposited by CVALD at low process temperatures. For example, aluminum oxide ceramic thin film with amorphous, smooth properties can easily be deposited conformally on high-aspect-ratio structures.

8. The wear-resistant, conformal multilayer structure multilayer (Al2O3/TiN) is inert and stable even in very harsh, corrosive environment. Both materials are approved for long-term (>10 yrs) human implantable uses where the environment is highly corrosive.

Irvine Sensors Corporation, assignee of the instant application, has conducted process studies for the wear-resistant, conformal multilayer structure coating of the invention to characterize the Al2O3 and TiN multilayer thin film process and to determine suitable fabrication processes, materials properties and performance of wear-resistant, conformal multilayer structure coatings.

TiN is the ALD coating of choice in many machine applications due to its excellent physical properties such as hardness, gold appearance, lubricating surface and chemical resistance.

Alumina in either bulk substrate or thin film coating form is the ALD material of choice for biomedical devices such as implantable amperometric glucose sensors used for long-term continuous glucose monitoring. For instance, sputtered alumina thin films have been used successfully to hermetically seal micro-via feed-throughs in implantable glucose sensors.

The thermal and electrochemical stability of both of the above materials allows their combined application as an excellent protective barrier to corrosion and erosion.

As a result, Cu micro-channel cooler heat exchangers with the wear-resistant, conformal multilayer structure coating of the invention can operate with a high confidence and reliability.

Without limitation, selected suitable materials that can be deposited by ALD for use with the invention and their properties are shown in Table 1. The wide selection of materials (metals, oxides, nitrides) that can be deposited by ALD offers micro-channel cooler process design flexibility for the wear-resistant, conformal multilayer structure coating in a micro-channel structure.

TABLE 1
ALD deposited materials and their properties.

| Deposition Material | Thickness | | Hardness | CTE (ppm) |
|---|---|---|---|---|
| Al2O3 (ALD) | ~1000 | Å | 1440 kg/mm2 | 7.4 |
| TiN (ALD) | ~1000 | Å | 3260 kg/mm2 | 9.4 |
| TiO2 (ALD) | 300-1000 | Å | | 9.0 |
| Ni (Electroplated) | >10000 | Å | 600 kg/mm2 | 12.5 |
| Au (Electroplated) | >1000 | Å | 55 kg/mm2 | — |

| | | | |
|---|---|---|---|
| Diamond | — | 8000 kg/mm2 | 1.2 |
| SiC | — | 2480 kg/mm2 | 4.6 |

Prior art, commercially supplied Cu micro-channel structures are generally fabricated using either chemical etching or by laser cutting small micro-channels in thin copper sheet metal material to define a first partial micro-channel structure and a second micro-channel structure.

The partial micro-channel structures are electroplated with an adhesion layer of Ni then Au. A complete Cu micro-channel cooler heat exchanger is then formed by bonding the first and second partial micro-channel structures to define a complete micro-channel structure.

For a heat exchanger with a thermal power dissipation requirement of about 100 W/cm2, the nominal channel dimensions may be about 300 um in height, about in 100 um width and about 200 um in pitch.

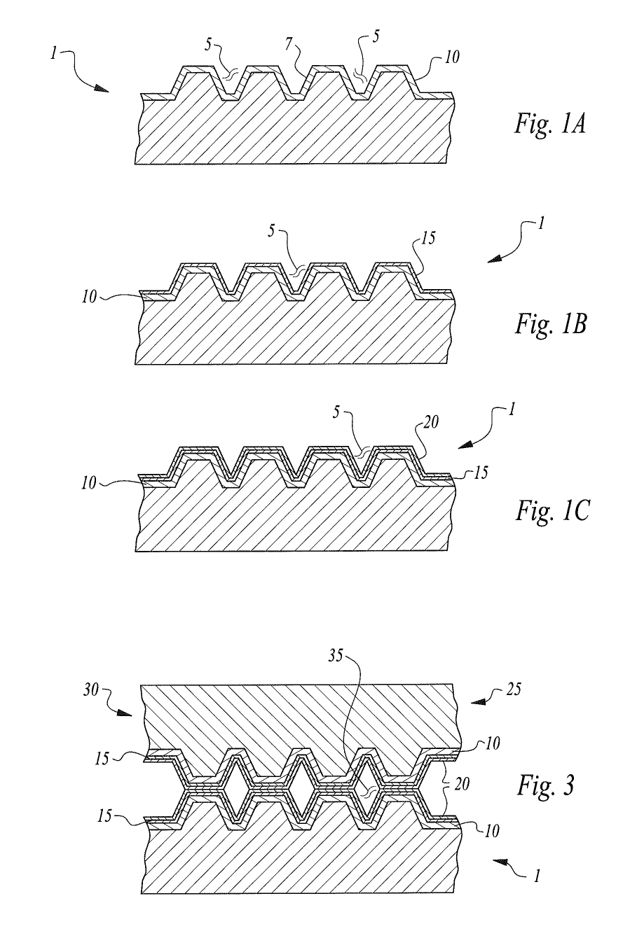

The fabrication sequence of the wear-resistant, conformal multilayer structure coating of the invention is depicted in FIGS. 1A, 1B and 1C.

In FIG. 1A, a prior art commercially supplied first partial Cu micro-channel structure 1 is depicted. First partial micro-channel structure 1 comprises one or more partial micro-channel volumes 5 comprising one or more partial micro-channel volume surfaces 7.

In typical instances where the first partial micro-channel structure 1 is provided as a commercially available micro-channel structure supplied with a base Ni layer and an exposed surface layer of Au, the preferred first step is to etch away the relatively soft exposed Au surface layer so that the wear-resistant, conformal multilayer structure coating has a strong Ni base support or adhesion layer 10 on volume surface 7. If not provided, a Ni layer or suitable adhesion layer of material is preferably deposited on the exposed volume surface 7 of the first partial micro-channel structure 1 as reflected in FIG. 1A.

A benefit of removing the Au surface layer is that in such commercially provided micro-channel structures where an Au layer exists, the Au surface has no oxide which would require providing an additional interface ALD adhesion layer such as Cr or Ti.

By etching away the Au, the Ni surface provides a natural oxide layer; hence the Al2O3 may be deposited directly on the exposed Ni surface without an added adhesion layer.

After etching and cleaning of the prepared adhesion layer 10, the next step is to prepare the first partial micro-channel structure 1 for the Al2O3 ALD deposition. A nominal thickness of the applied Al2O3 layer 15 is about 1000 Å and is grown atomic layer-by-layer via CVALD as is illustrated in FIG. 1B.

The next deposited layer is a TiN layer 20 with a thickness of about 300 Å-1000 Å which is then deposited on top of the alumina ceramic layer using the same ALD process equipment as shown in FIG. 1C.

Visual inspection under 1000× optical microscope and SEM is preferably performed after each process step.

The multilayer coating of FIG. 1C has a key performance advantage. The Cu micro-channel cooler Ni/Al2O3/TiN multilayers have a corresponding coefficient of thermal expansion of about 16 ppm/12.5 ppm/7.4 ppm/9.4 ppm as listed in Table 1. This gradual step-down in thermal expansion across the layers improves thermal mismatch and minimizes potential cracking due to rapid temperature swings. Combined with the low temperature CVALD deposition process, this multilayer ultrathin-film coating has low residual stresses which also improves the coating reliability due to reduced potential for thermo-mechanical cracking.

High resolution SEM may be used to provide information on the sharpness of the step edge coverage, especially for ultra-thin film multilayer structures where it is important to have a clear interface and well-defined step edges. The wear-resistant, conformal multilayer structure coating surface topology can be readily obtained using both atomic force microscopy (AFM) and optical confocal microscopy such as the Hyphenated Systems HS200 optical profiler microscope or be characterized by measuring surface topology and mapping the elemental composition using energy dispersive X-ray spectroscopy (EDS).

Micro- and nano-pin-holes in ultra-thin films can be difficult to locate even under high resolution SEM inspection. A suitable technique for detecting pin-holes in insulating passivation films is through electrochemical acceleration testing. Electrochemical testing is a well-known technique used to identify small pin-holes by plating out the underlying metals. For the instant Cu micro-channel cooler embodiment application, the underlying metals are Ni and Cu.

The first step in a preferred method of electrochemical testing is to protect all the surfaces of the Cu micro-channel cooler with dicing “blue” tape with the exception the target surfaces of interest. The Cu micro-channel cooler is then submersed in a conductive solution and connected to the anode of the testing system so that the exposed underlying Ni metal (if any) can be plated out to the system cathode electrode. Next, the pin-holes may be visually enhanced by plating out any Cu under the Ni layer.

To visualize the pin-holes, Applicant has successfully used a fluorescent marker (commonly used in biological study) to facilitate the identification of micro-pin-holes from previous biomedical device development. In such instance, the Cu micro-channel cooler is soaked in a fluorescent dye at about 60 C under a few atmosphere of pressure for about two hours to allow the dye to diffuse into any pin-holes. The cooler is rinsed under flowing water and blown dry with N2 gas. The Cu micro-channel cooler is then inspected for pin-holes under a fluorescent microscope with 20× or greater magnification. If there are any pin-holes, they will grow and be easily identified. This provides a reliable method to identify or quantify any micro/nano pin-holes that might exist in the structures.

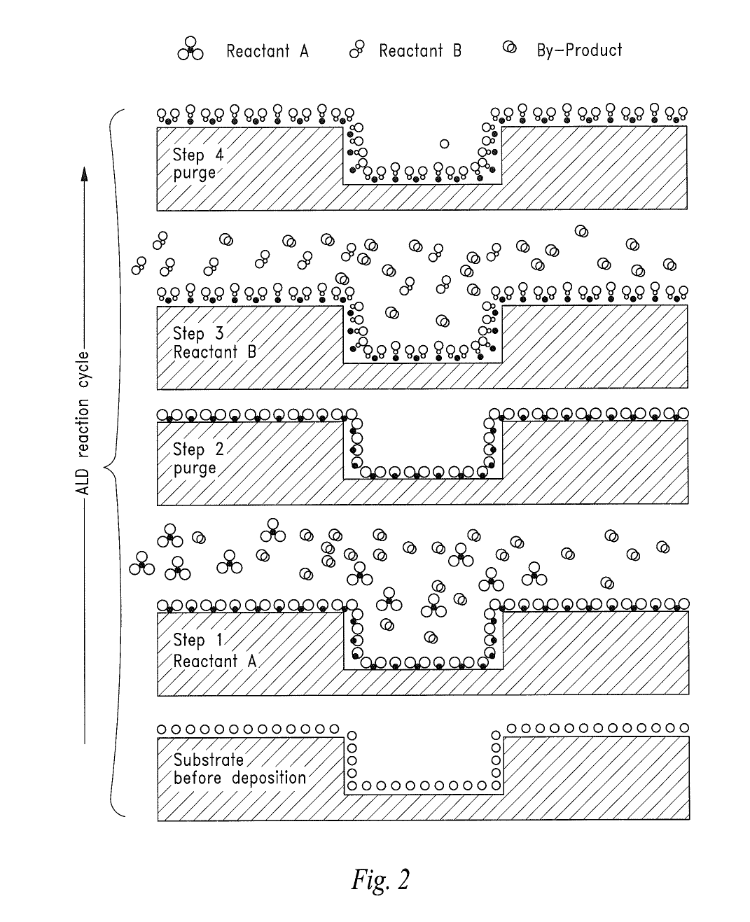

Turning now to the ALD reaction cycle illustration of FIG. 2, ALD layers are deposited by a repetitive sequence of two basic pulsing cycles. The two pulsing cycles deposit one complete single layer of material.

The surface of the structure is prepared to react directly with a predetermined first molecular reactant A. The structure is exposed to reactant A in Step 1 which reacts with the initial sites to form a subatomic layer (half reaction). After the first reaction is complete, the by-products of first predetermined reactant A are purged in Step 2 from the chamber and the surface is exposed to a second predetermined reactant B in Step 3. This reaction completes the film deposition (one layer) and regenerates the initial functional groups and prepares the surface for the next layer as illustrated in Step 4.

Restoring the initial surface after completing the second deposition cycle is a key benefit of the ALD process. Both reactions A and B are self-terminating and the combined AB cycles form one complete film layer. The film may be grown to the desired thickness by repeating this AB sequence.

The typical layer growth rate at 170° C. is about 1.0 Å/cycle with a cycle time of 12 seconds. TiN may be deposited using the same equipment and similar process flows as Al2O3. Both the Al2O3 and TiN films deposited by ALD are amorphous and smooth which is particularly well-suited for fine features and micro-channel applications as a wear-resistive coating.

The ALD film growth of the invention is preferably based on chemical vapor (CV) to achieve conformal deposition in a micro-channel structure. In conventional chemical vapor deposition, both gases are fed simultaneously into a chamber and the substrate is kept at high enough temperature to promote a chemical reaction between the two gases to deposit the pure film and not the byproducts.

For CVALD on the other hand, the molecular precursors (gases) are introduced into the chamber one at a time. The ALD reaction takes place only if the surface is prepared to react directly with the molecular precursor. This important self-limiting process in CVALD offers exceptional film thickness control at the atomic level. In addition, the self-saturating surface reactions make CVALD insensitive to transport non-uniformity from surface topology such as high-aspect-ratio Cu micro-channel cooler.

Turning to FIG. 3, it can be seen that a first partial micro-channel structure 1 comprising an adhesion layer, an Al2O3 layer and a Ti/N layer is assembled with and bonded to a second partial micro-channel structure 25 comprising an adhesion layer, a Al2O3 layer and a Ti/N layer fabricated in like manner to define a wear-resistant multilayer micro-channel structure 30 comprised of one or more wear-resistant, multi-layer micro-channel volumes 35 such as may be used in a micro-channel cooling device.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

I claim:

1. A micro-channel structure comprised of:
at least one micro-channel volume comprising an interior surface,
at least one layer of a predetermined material having a predetermined physical property deposited on the interior surface by an atomic layer deposition process.

2. The micro-channel structure of claim 1 wherein the layer is about 1000 angstroms in thickness.

3. The micro-channel structure of claim 1 wherein the layer has a hardness of about 1440 kg/mm2.

4. The micro-channel structure of claim 1 wherein the layer has a hardness of about 3260 kg/mm2.

5. The micro-channel structure of claim 1 comprising a plurality of micro-channels having a pitch of about 200 microns.

6. The micro-channel structure of claim 1 wherein the predetermined material is a Ti/N material.

7. The micro-channel structure of claim 1 wherein the predetermined material is a Ti/O2 material.

8. The micro-channel structure of claim 1 wherein the predetermined material is an Al2O3 material.

9. A method for making a micro-channel structure comprising the steps of:
providing a first partial micro-channel structure having at least one first partial micro-channel volume defined therein,
providing a second partial micro-channel structure having at least second first partial micro-channel volume defined therein,
depositing a predetermined material having a predetermined physical property on the surface of the first and second partial micro-channel volumes using an atomic layer deposition process,
assembling the first and second partial micro-channel structures to define a micro-channel structure comprising at least one micro-channel volume.

10. The method of claim 9 wherein the layer is about 1000 angstroms in thickness.

11. The method of claim 9 wherein the layer has a hardness of about 1440 kg/mm2.

12. The method of claim 9 wherein the layer has a hardness of about 3260 kg/mm2.

13. The method of claim 9 wherein the predetermined material is a Ti/N material.

14. The method of claim 9 wherein the predetermined material is a Ti/O2 material.

15. The method of claim 9 wherein the predetermined material is an Al2O3 material.
